(19) United States
(12) Patent Application Publication
(10) Pub. No.: US 2010/0117818 A1
(43) Pub. Date: May 13, 2010

(54) SPEED-REDUCTION ALERT DEVICE

(76) Inventor: HOU-WANG KAO, Taipei Hsien (TW)

Correspondence Address: HOU-WANG KAO, 235 Chung-Ho, Box 8-24, Taipei, 235, TW

(21) Appl. No.: 12/268,453

(22) Filed: Nov. 11, 2008

(51) Int. Cl. B60Q 1/50

(52) U.S. Cl. 340/467

(57) ABSTRACT

A speed-reduction alert device comprises a speed-reduction alert unit installed below a gas pedal for detecting swinging operation of the gas pedal so as to transfer a swing signal outwards; a computer main frame connected to the speed-reduction alert unit for receiving the swinging signals and controlling the flash frequencies, flash periods and change of signals of a brake light in a first car to show a deceleration of the first car to a driver of a second car so that the driver of the second car will alert the deceleration of the first car. When the gas pedal is pressed downwards for acceleration, the computer main frame will determine that it is an accelerating signal and the brake light is not actuated; and when the gas pedal is released to move upwards for deceleration, the computer main frame will determine that it is a deceleration signal.

### FIELD OF THE INVENTION

The present invention relates to car safety devices, and particularly to a speed-reduction alert device, wherein the deceleration of the first car will alert to the second car so that the driver of the second car will known the action of the first car and thus has a long reaction time. In the present invention, a speed-reduction alert unit is installed to a gas pedal so as to control the flash of the brake light through a computer main frame.

### BACKGROUND OF THE INVENTION

In the principle of brake lights, when a first car driving along a highway has an accident, the driver of the first car will remove his (or her) leg from the gas pedal and to the brake pedal for braking. Thus the brake light will light up to alert the driver of a second car behind the first car so that the two cars can retain with a safe distance therebetween. However at the moment that the leg of the driver of the first car removes from the gas pedal and moves to the brake pedal, the first car will decelerate so that at this moment, the second car will move close to the first car and thus it is very possible that the second car will collide the first car. However this especially occurs when the cars move with high speeds.

### SUMMARY OF THE INVENTION

Accordingly, the object of the present invention is to provide a speed-reduction alert device, wherein the deceleration of the first car will alert to the second car so that the driver of the second car will known the action of the first car and thus has a long reaction time.

Moreover, in the present invention, a speed-reduction alert unit is installed to a gas pedal so as to control the flash of the brake light through a computer main frame.

To achieve above object, the present invention provides a speed-reduction alert device comprising: a speed-reduction alert unit installed below a gas pedal for detecting swinging operation of the gas pedal so as to transfer a swing signal outwards; a computer main frame connected to the speed-reduction alert unit for receiving the swinging signals and controlling the flash frequencies, flash periods and change of signals of a brake light in a first car to show a deceleration of the first car to a driver of a second car so that the driver of the second car will alert the deceleration of the first car; wherein when the gas pedal is pressed downwards for acceleration, the computer main frame will determine that it is an accelerating signal and the brake light is not actuated; and when the gas pedal is released to move upwards for deceleration, the computer main frame will determine that it is a deceleration signal so as to control the brake light to flash.

The various objects and advantages of the present invention will be more readily understood from the following detailed description when read in conjunction with the appended drawing.

### BRIEF DESCRIPTION OF THE DRAWINGS

FIG. 1 shows the operation flow diagram of the speed-reduction alert device of the present invention.

FIG. 2 is a schematic view showing the state of the speed-reduction alert device before action.

FIG. 3 is a schematic view showing the state of the speed-reduction alert device after action.

FIG. 4 shows another action of the speed-reduction alert device of the present invention.

FIG. 5 shows a further action of the speed-reduction alert device of the present invention.

FIG. 6 is schematic view showing a yet action of the speed-reduction alert device of the present invention.

FIG. 7 is a schematic view showing the other action of the speed-reduction alert device of the present invention.

FIG. 8 is a schematic view about another example of the speed-reduction alert device of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

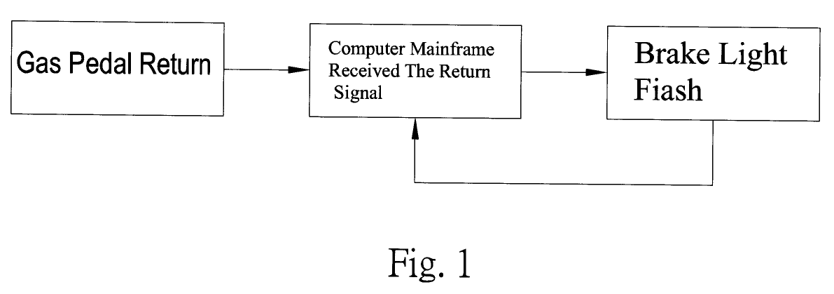

Referring to FIG. 1, the block diagram of the speed-reduction alert device of the present invention is illustrated. The speed-reduction alert device of the present invention comprises a speed-reduction alert unit 100 installed below a gas pedal 2 for detecting swinging operation of the gas pedal 2 so as to transfer a swing signal outwards;

A computer main frame 1 is connected to the speed-reduction alert unit 100 for receiving the swinging signals and controlling the flash frequencies, flash periods and change of signals of a brake light 3 in a first car to show a deceleration of the first car to a driver of a second car so that the driver of the second car will alert the deceleration of the first car.

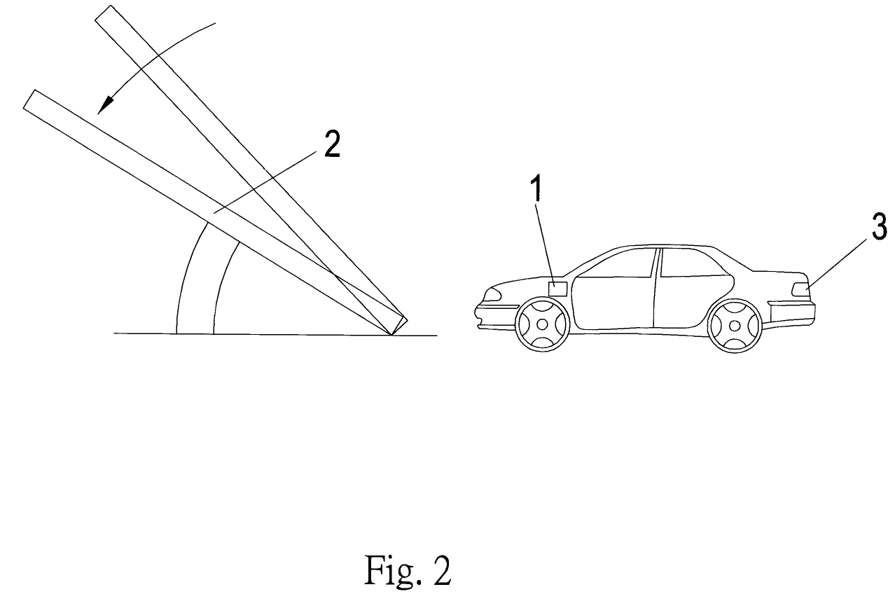

Referring to FIG. 2, according to the operation of the present invention, when the gas pedal 2 is pressed downwards for acceleration, the computer main frame 1 will determine that it is an accelerating signal and the brake light 3 is not actuated.

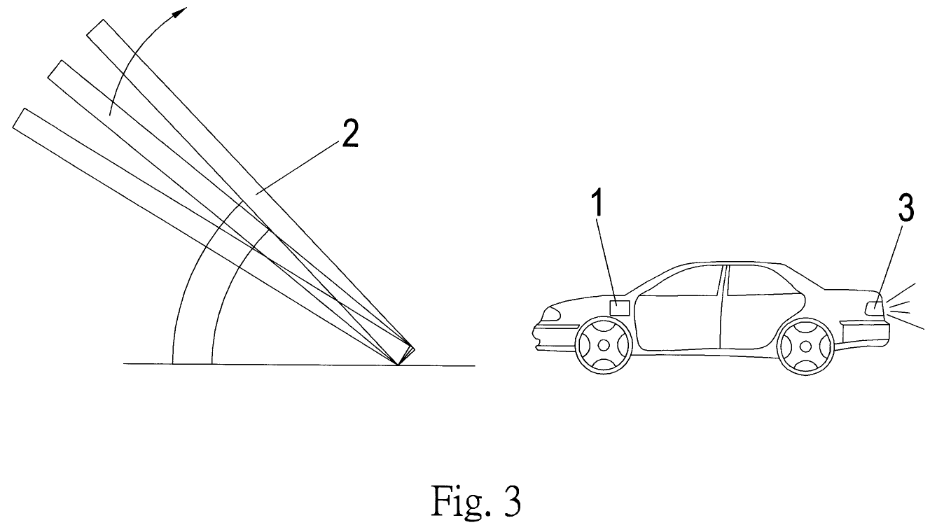

Referring to FIG. 3, when the gas pedal 2 is released to move upwards for deceleration, the computer main frame 1 will determine that it is a deceleration signal so as to control the brake light 3 to flash.

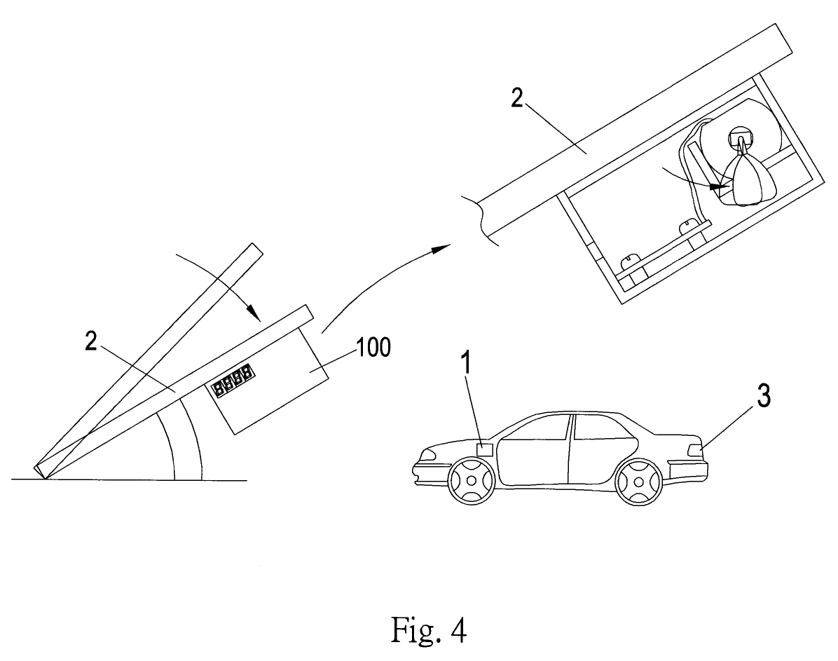

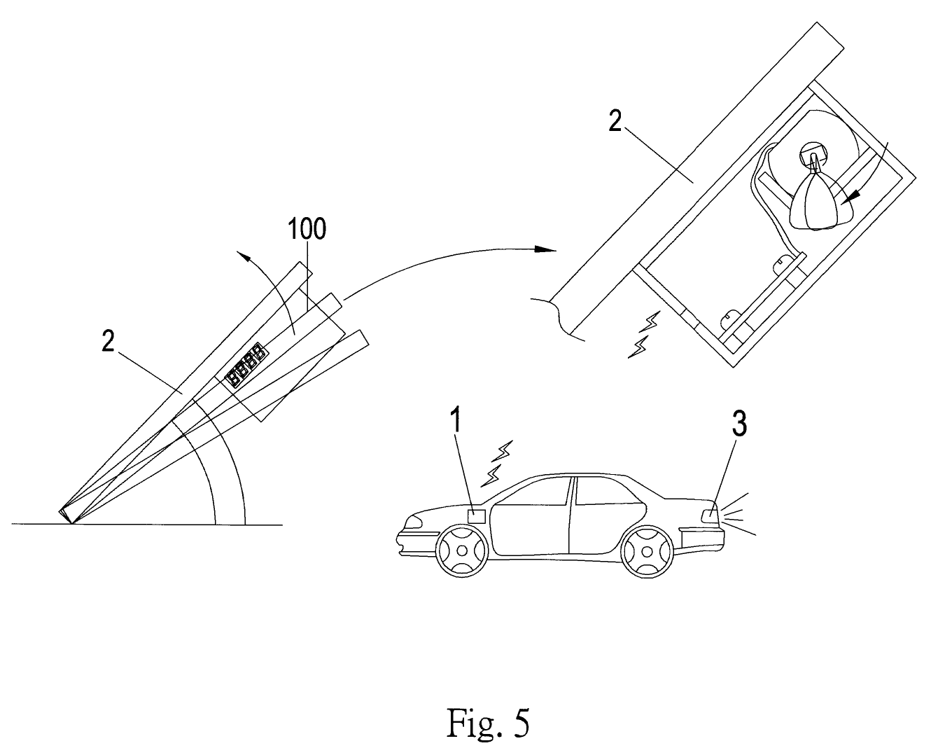

Referring to FIGS. 4 and 5, in this case, the speed-reduction alert unit 100 is a wireless device, where the signals transmission are wireless. When the gas pedal 2 presses downwards for acceleration, the speed-reduction alert unit 100 will move forwards along an axle center since a swing unit swings so that a seat of a control circuit board will generate positive signals and thus it do not act. When the gas pedal 2 is released, and thus the speed is reduced, the speed-reduction alert unit 100 will swing backwards so that the control circuit board with generate negative signals so that the brake light 3 will flash (the coder adjusts the flash frequencies, flash sped and change of signals and the speed-reduction alert unit 100 is controlled by the computer main frame 1.)

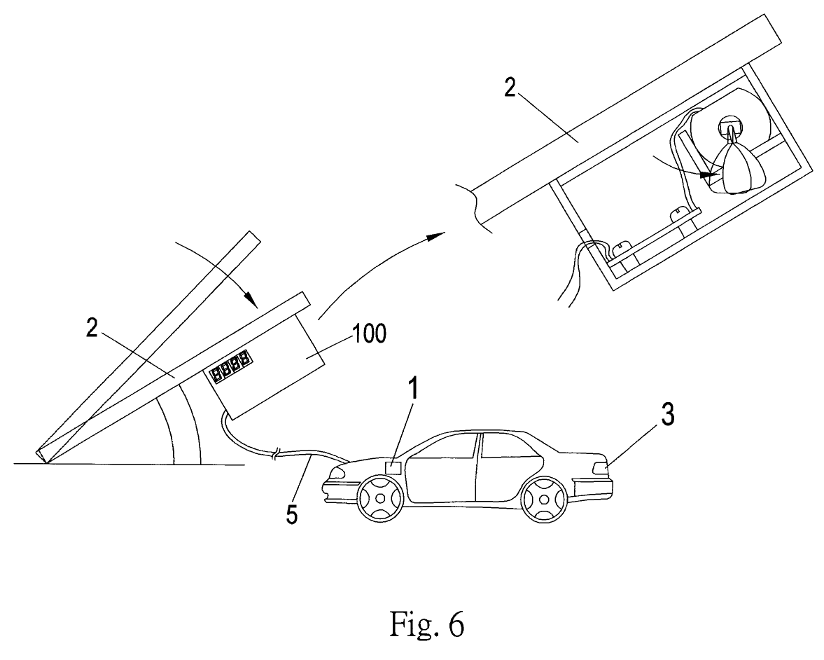

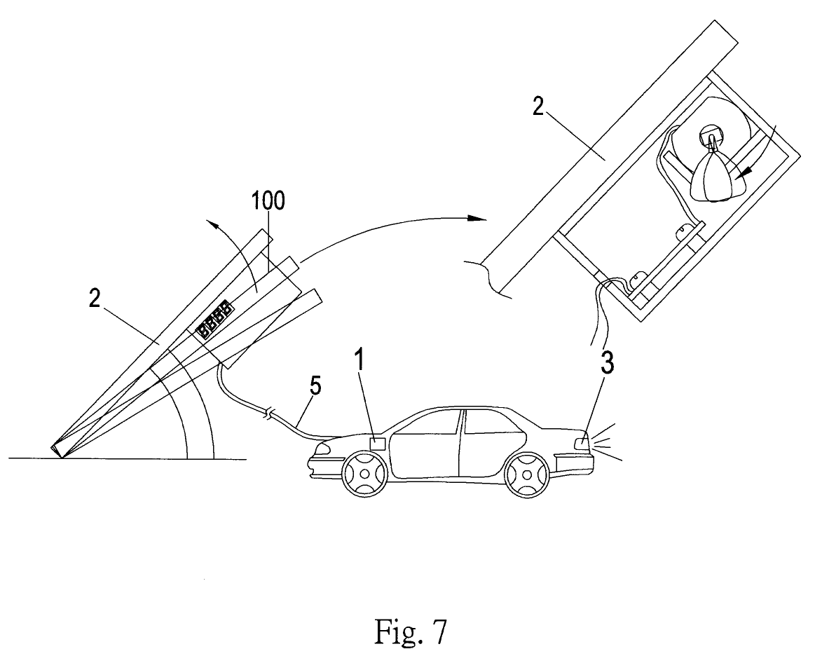

Referring to FIGS. 6 and 7, it is illustrated that the speed-reduction alert unit 100 is a wired device, in that the signals are transferred to the computer main frame 1 through a signal wire 5. When the gas pedal 2 presses downwards for acceleration, the speed-reduction alert unit 100 will move forwards along an axle center since a swing unit swings so that a seat of a control circuit board will generate positive signals and thus it do not act. When the gas pedal 2 is released, and thus the speed is reduced, the speed-reduction alert unit 100 will swing backwards so that the control circuit board with generate negative signals so that the brake light 3 will flash (the coder adjusts the flash frequencies, flash sped and change of signals and the speed-reduction alert unit 100 is controlled by the computer main frame 1.)

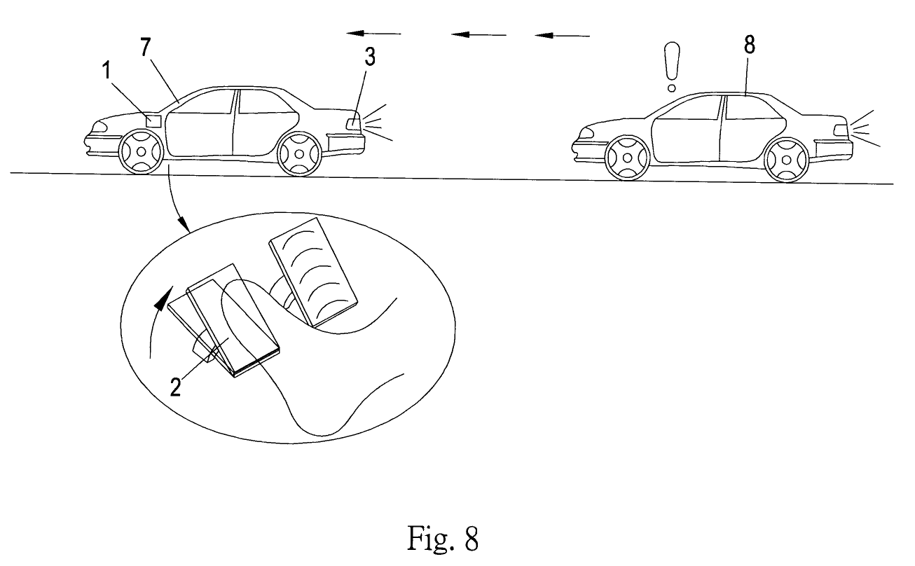

With referring to FIG. 8, it is illustrated that the driver of the first car 7 removes the leg from the gas pedal 2, the first car is decelerated. Now the computer main frame 1 will determine that the first car is decelerated so that the brake light 3 will flash to alert the second car 8 about this state and thus the driver of the second car has a longer time for reaction.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A speed-reduction alert device comprising:
a speed-reduction alert unit installed below a gas pedal for detecting swinging operation of the gas pedal so as to transfer a swing signal outwards;
a computer main frame connected to the speed-reduction alert unit for receiving the swinging signals and controlling the flash frequencies, flash periods and change of signals of a brake light in a first car to show a deceleration of the first car to a driver of a second car behind the first car so that the driver of the second car will alert the deceleration of the first car;
wherein when the gas pedal is pressed downwards for acceleration, the computer main frame will determine that it is an accelerating signal and the brake light is not actuated; and when the gas pedal is released to move upwards for deceleration, the computer main frame will determine that it is a deceleration signal so as to control the brake light to flash.

2. The speed-reduction alert device as claimed in claim 1, wherein the speed-reduction alert unit is connected to the computer main frame by using wire connection.

3. The speed-reduction alert device as claimed in claim 1, wherein the speed-reduction alert unit is wirelessly connected to the computer main frame.

4. A speed-reduction alert device as claimed in claim 1, wherein an encoder is installed in the computer main frame for controlling the flash frequencies, flash periods and the change of the signals of the brake light.
